(19) United States
(12) Patent Application Publication
(10) Pub. No.: US 2002/0109891 A1
(43) Pub. Date: Aug. 15, 2002

(54) Transmitter for generating optically coded signals, a method of generating optically coded signals and a transmission system

(75) Inventor: Thomas Pfeiffer, Stuttgart (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/058,167

(22) Filed: Jan. 29, 2002

(30) Foreign Application Priority Data
Feb. 14, 2001 (DE) 101 07 110.8

(51) Int. Cl. H04B 10/04

(52) U.S. Cl. 359/180; 359/181

(57) ABSTRACT

A transmitter for generating optically coded signals, with a light source for the generation of a broadband optical spectrum, is proposed. Also described is a method of generating optically coded signals and a transmission system for the transmission of optically coded signals.

### BACKGROUND OF THE INVENTION

The invention is based on a priority application DE 101 07 110.8 which is hereby incorporated by reference. The invention is based on a transmitter for generating optically coded signals with a light source for generating a broadband optical spectrum, a circuit for modulating the broadband optical signal with a data signal, and an encoding filter. The invention is also based on a method of generating optically coded signals for transmission in a communications network. The invention is further based on a transmission system using a transmitter for the generation of optically coded signals.

A method and system for the transmission of optically coded signals is known for example from DE 19723103.9. An optical transmission system for the transmission of optically coded signals contains transmitters, transmission paths and receivers. Each transmitter contains an encoder in which the signals to be transmitted are coded prior to their transmission into the optical transmission system. The encoding takes place optically, for example by means of frequency coding using an optical filter. Each receiver in the transmission system which is to receive the optical signals transmitted by the transmitter must contain a decoder which is tuned to a special encoder of a transmitter. In the simplest case the frequency bands which are transmissive for optical signals and the frequency bands which are blocked for optical signals are the same in the case of the coder in the transmitter and in the case of the decoder in the receiver. These transmission systems are known under the term CDM (code division multiplex). The receivers in a CDM transmission system are constructed as differential receivers in the prior art. Only in this way is it possible to eliminate the cross-talk effects which occur in a CDM transmission method. The demands on the differential receivers are correspondingly high and lead to cost-intensive and complex devices. For example DE 19748756 has disclosed a differential receiver of this kind. The complex construction of the receiver for use in a CDM system limits the bit rate for a transmission channel due to different properties of the components. The necessary tunings which would be needed in order to increase the bit rate to over 1 Gbit per second lead to a further outlay and additional costs for the production of a receiver.

The as yet unpublished DE 10035074 has disclosed a CDM transmission method which, extended by an optical signal processor, considerably reduces the outlay in the receiver. In this method, as well as the coded signal the respective inverted signal is generated and these are superimposed to form a common signal. The resultant signal no longer contains any intensity modulation. In the receiver the decoding of this “quasi-constant” signal is easily possible; all the channels whose coding does not correspond to the decoding of the receiver are transmitted with a constant power. For those channels whose coding does not correspond to the decoding of the receiver, a spectrally-encoded “1” is transmitted with a specific power. As the optical processor also supplies the same signal level in the case of a “0”, the same power is likewise transmitted in the receiver. Only the channel with the matching coding generates an output signal which is somewhat greater in the case of a “1” than in the case of a “0”. The incorporation of an optical signal processor into a transmission system constitutes an additional element and an additional outlay.

A so-called coherent multiplex method is also known from the prior art (G. J. Pencock et al. “Capacity of . . . ”, Optical Communications 143, p. 109-117, 1997). In such a transmission system, inverted signals are likewise generated and superimposed. The generation of the inverted signals necessitates a detuning of the optical filter which is used. This method is too complex for use in a cost-effective and simple transmission system.

The transmitter according to the invention for generating optically coded signals has a simple construction comprising broadband light source, a circuit for modulating the broadband signal, and an encoding filter with two inputs. The encoding filter codes the applied signals in passive fashion and is not tuned.

### SUMMARY OF THE INVENTION

Further exemplary embodiments of the invention will be explained in detail in the following description. In the drawing:

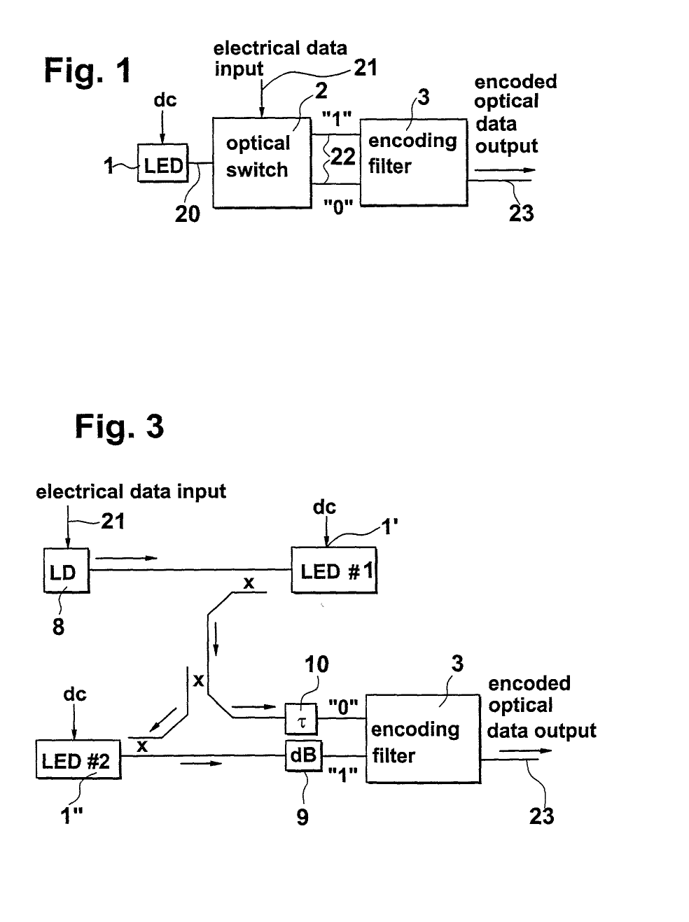

FIG. 1 schematically illustrates the construction of an optical filter;

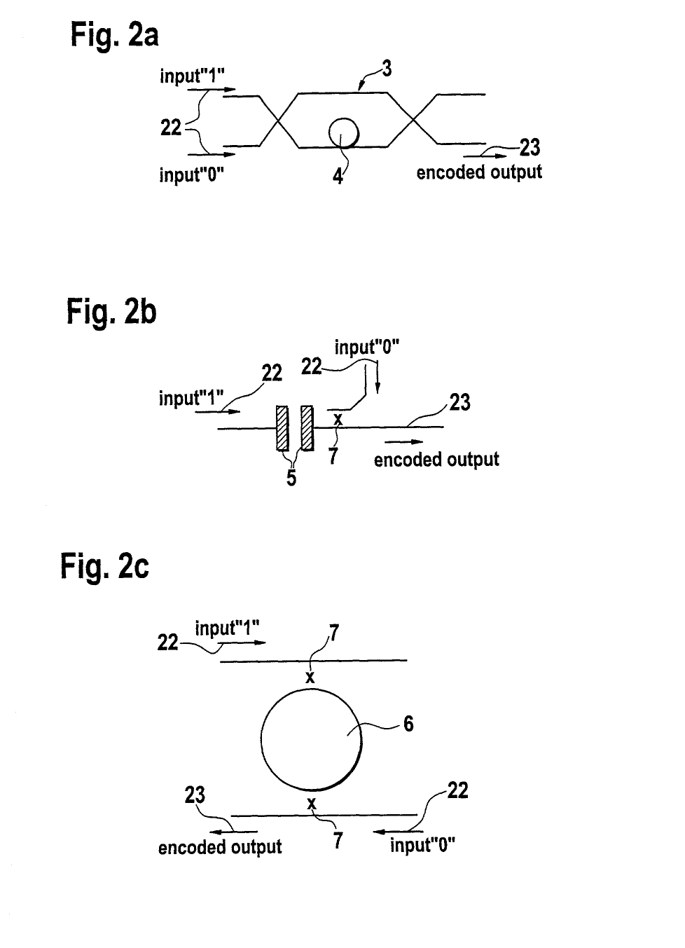

FIG. 2a illustrates a Mach-Zehnder filter;

FIG. 2b illustrates a Fabry-Perot filter,

FIG. 2c illustrates a ring-resonator filter and

FIG. 3 illustrates an embodiment for the optical switch.

In FIG. 1 a LED1 is connected to an electro-optical switch 2. The electro-optical switch 2 has an input for an electrical data signal 21. The electro-optical switch 2 also has two outputs 22. These outputs 22 are connected to the inputs of a encoding filter 3. The output of the encoding filter 3 is connected to a transmission path. In this example arrangement, the LED1 is connected to a DC driver. In an embodiment the LED is connected to an intensity modulator. An intensity modulator of this kind has a Mach-Zehnder structure and possesses two complementary outputs 22. The signals of these two outputs 22 each correspond to a logic “1” or “0”. The two arms of the Mach-Zehnder modulator are connected to the inputs of an encoding filter 3. An optical spectrum which has a coding corresponding to the filter transmission curve is present at the output of the encoding filter 3. This filter curve, or its complementary supplementation, are a function of the two inputs and the signals applied thereto.

A first embodiment of the encoding filter 3 is shown in FIG. 2a. The two inputs for the encoding filter are the two arms of a Mach-Zehnder filter. Here the signal of a logic “1” is applied to the upper arm of the Mach-Zehnder filter. Conversely, if a logic “0” is coded, the input signal is applied to the lower arm of the Mach-Zehnder filter. In the coding, at the output end there occurs a signal which is coded according to the input arm and is in each case complementary. FIG. 2b illustrates an encoding filter with a Fabry-Perot construction. Here the input for the logic “1” is connected directly to the reflector 5. The coded signal occurs in transmission of the Fabry-Perot interferometer. The input signal of the logic “0” is applied via a coupler 7 to the output reflector of the Fabry-Perot interferometer. This signal is coded in reflection. In a third exemplary embodiment as shown in FIG. 2c, a ring-resonator filter is used. The ring-resonator contains two couplers 7 and has two inputs which input-couple the signal in different directions. This likewise results in a complementary coding for the respective signal inputs “1” and “0”.

FIG. 3 illustrates an embodiment for the optical switch 2. Here an emitter for broadband ASE (Amplified Spontaneous Emission) is used. Such an emitter for amplified spontaneous emission is known from Application DE 10013718.0. Here an optical semiconductor amplifier is used for example. The semiconductor amplifier is excited with a constant operating current so that a constant, broadband ASE is emitted. The emission is constant for such time as no optical signal is applied to the semiconductor amplifier. If a coded 1 arrives via the transmission path, the ASE of the semiconductor amplifier is reduced. If a 0 is applied at the input end, the semiconductor amplifier emits its maximum ASE. The emitted ASE power is inverted compared to the input power. A LED can also be used as broadband emitter of ASE. FIG. 3 illustrates an exemplary embodiment using LEDs. A laser diode 8 is modulated in its intensity with electrical data. The laser diode 8 is connected to a LED 1′. The LED 1′ is operated with a d.c. voltage. The LED 1′ is connected both to the first input of the encoding filter 3 and to the input of a second LED 1″. The second LED 1″ is connected to the second input of the encoding filter 3. If the laser diode 8 emits a “1”, thus with “light on”, the emission is reduced in the case of the DC-driven LED 1′ through the laser light. If no (or only a small signal) emanates from the first LED 1′, the second LED 1″ is active. The broadband emission is then coded by the encoding filter 3. The coding takes place via the input “1” of the encoding filter. Otherwise the laser diode is switched off. The LED 1′ generates a broadband light signal which is applied to the LED 1″. This signal is applied to the input “0” of the encoding filter. The second LED 1″ emits no signal. At the output of the encoding filter 3 the 1 and the 0 are differently coded in complementary spectra. The light signals of the two LEDs are offset in time and have the same intensity. As a result, an output intensity which is constant in time occurs downstream of the encoding filter 3. In the embodiment according to FIG. 3 a delay element 10 has been shown. Also shown is an attenuating element 9.

These two elements are not absolutely essential. Rather, they indicate that in an optimised embodiment, an adaptation of the time and of the amplitudes of the light signals is performed. These elements are arranged upstream of the encoding filter.

1. A transmitter for generating optically coded signals with a light source for generating a broadband optical spectrum, a circuit for modulating the broadband optical signal with a data signal, the optical output signal being split between two inverted outputs of the circuit, and an encoding filter which in each case optically codes the two inverted optical output signals to form a transmission signal.

2. A transmitter according to claim 1 using a Mach Zehnder filter.

3. A transmitter according to claim 1 using a Fabry-Perot filter.

4. A transmitter according to claim 1 using a ring-resonator filter.

5. A transmitter according to claim 1 with a laser diode which is modulated with the data signal, a first broadband light source and a second broadband light source which are connected to one another and in each case to an input of an encoding filter.

6. A transmitter according to claim 5 with a delay element and/or an attenuating element for the adaptation of the signals incoming into the encoding filter.

7. A method of generating optically coded signals for transmission in a communications system:
generation of broadband optical signals,
modulation of two optically inverted output signals with an electrical data signal,
optical coding of the output signals and superimposition to form a transmission signal.

8. A transmission system for the transmission of optically coded signals using a transmitter according to claim 1.
